(19) United States
(12) Patent Application Publication
(10) Pub. No.: US 2023/0306064 A1
(43) Pub. Date: Sep. 28, 2023

(54) METHOD AND SYSTEM FOR SEARCHING HISTORICAL VERSIONS USED FOR DEVELOPING DOCUMENTS FOR DOCUMENT AND DATA MANAGEMENT TOOLS

(71) Applicant: Microsoft Technology Licensing, LLC, Redmond, WA (US)

(72) Inventors: Nidhi VERMA, Redmond, WA (US); Neetha Sumana TULURI, Sammamish, WA (US); John R. BERKELEY, Kenmore, WA (US); Roberta CANNEROZZI, Bellevue, WA (US); Kristofer Duncan HOFFMAN, Sammamish, WA (US)

(73) Assignee: Microsoft Technology Licensing, LLC, Redmond, WA (US)

(21) Appl. No.: 17/703,739

(22) Filed: Mar. 24, 2022

(51) Int. Cl. G06F 16/93; G06F 16/903

(52) U.S. Cl. CPC G06F 16/93; G06F 16/90335

(57) ABSTRACT

A system and method to allow an authorized searcher to conduct a search of a current primary version of a document being developed in an application as well as versions of the document which were used in the development of the current primary version. In an exemplary system, instructions cause a processor to grant a search request to search, via a search index in a cloud storage, stored selected versions of the document. The stored selected versions of the document are historical versions of the current primary version of the document which has been selected from among the stored selected versions to be accessible, via the search index, to other searchers having a lower access authorization than the predetermined access authorization. The authorized searcher is provided with a capability to toggle between searching only the primary version of the document and searching the stored selected versions of the document.

### BACKGROUND

In document and data management tools, such as Microsoft SharePoint Online™ (hereinafter referred to as SPO), it is possible to develop documents, for example, for projects, with the contributions of multiple users. In such arrangements, the users often have different levels of authorization for management of the development of the documents. In such document and data management tools, the most crucial and simplest customer requirement is that any version of a document that is visible in in the program should be retrievable in search results. In other words, for many search purposes, such as conducting legal discovery or performing audits, it is often necessary to be able to search not only the current version of a document under development, but also historical versions that were used to develop the current version of the document. However, in current document and data management programs, such as SPO, the search ingestion pipeline keeps only the latest primary (e.g., major) version of a document in a search index which is available for search functionality.

For example, if a document has multiple versions (e.g., 0.1, 0.2, 1.0, 2.0, 2.1, 2.2, 3.0 and 4.0) in the application program over the course of developing the document, the search ingestion pipeline will process each version of document sometime after the change happens, but only keep the last primary version in a record index (for example, a search index in cloud storage) by overwriting the previous primary version. In other words, in the above example where there have been three previous primary versions 1.0, 2.0 and 3.0, in previous searching systems only the current primary version 4.0 will be available for search via the search index, notwithstanding that several other versions are actually stored in cloud storage as historical versions of the document, as well as the previous primary versions which are also historical versions. Although this arrangement is efficient in terms of reducing the time required for conducting a search of the current primary version of the document, it does not provide an optimum experience for many customers, and does not meet some other requirements such as compliance requirements for a discovery search for legal proceedings. In such cases, it is necessary to search not only the current primary version of the document, but also historical versions of the document that have been saved since the last current primary version was saved, in other words, historical versions of the document or project while it is being developed (including previous primary versions that have been overwritten to be replaced by new primary versions). Regarding this, it is noted that the term “primary version” is being used herein to represent a current version of the document being developed which has been selected to be the version which is available in a search index, for example, in a cloud storage search index arrangement, for viewing and searching by searchers with only a low level search access authorization (e.g., read-only viewing).

FIG. 1 shows an example of the above-noted problem of a searcher not being able to access all of the necessary information required, for example, for a search used for legal discovery, or during an audit, with regard to the document for a project under study or investigation. Taking an example of a search conducted for legal electronic discovery to search documents or projects being developed by a plurality of users in SPO, a user would be unable to fulfill the compliance requirements of the legal discovery process regarding historical versions (e.g., versions and previous primary versions used in developing the document) as it is being developed. Specifically, referring to FIG. 1, the document XYZ being searched for is stored in previous SPO primary Versions 1.0 and 2.0 under the reference to claim 12-3456-78. However, because the current primary version is Version 4.0, and because this Version 4.0 is the only version that can be searched with a search index using current search tools, such as tools for electronic discovery, a searcher will be unable to discover the necessary document XYZ because the Versions 1.0 and 2.0 have been removed from the search index. Therefore, in order to improve the ability to search for relevant documents, without unduly slowing down the search procedure, an improved search method and system is provided herein which allows access not only to the current primary Version 4.0 but also to the earlier primary Versions 1.0, 2.0 and 3.0 for document discovery.

### SUMMARY

In an implementation, a system is provided including one or more processors and one or more machine-readable media storing instructions which, when executed by the one or more processors, cause the one or more processors to grant a first search request from a first searcher having a predetermined access authorization, to search, via a search index in a cloud storage, stored selected versions of a document, in which stored selected versions have been developed in an application based on contributions of a plurality of users to produce versions of the document in the application, wherein the stored selected versions of the document are historical versions of a current primary version of the document which has been selected from among the stored selected versions to be accessible, via the search index, to other searchers having a lower access authorization than the predetermined access authorization, other searchers do not have access to the stored selected versions, and the first searcher is provided with a capability to toggle between searching only the primary version of the document and searching the stored selected versions of the document.

In another implementation, a method is provided including developing a document in an application based on contributions of a plurality of users to produce versions of the document in the application, pushing one or more selected ones of the versions from the application to cloud storage as stored versions in the cloud storage, and selecting a latest one of the stored versions of the document to be a primary version of the document which is accessible to searchers with a limited access authorization via a search index, wherein a determination as to when to push the selected one or more of the versions from the application to the cloud storage is based on at least one of: a ranking of the users making changes to the selected one or more of the stored versions in the application in relation to a level of authorization for making changes to the document; a number of times changes have been made to the selected one or more of the versions in the application by the users since the primary version has been selected; the number of users that are using or modifying the selected one or more of the versions in the application; and how often the selected one or more of the versions is being used in the application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates an example of a problem in discovering material available only in previous versions of a document.

FIG. 2 shows an overview of how a search for information in stored documents works using an index of the storage system (e.g., cloud storage), in accordance with aspects of the present disclosure.

FIGS. 3A-3C show operations of a system for storing, in a cloud storage system, versions of a document as it is being developed to permit searching of historical versions used to develop a current primary version of the document, as well as previous primary versions of the document and historical versions of the document developed more recently than the current primary version, in accordance with aspects of the present disclosure.

FIG. 4 is a flow diagram showing operations for pushing selected versions of a document under development, and selection of a primary version of the document for general searching in a search index, in accordance with the aspects of the present disclosure.

FIG. 5 is a flow diagram showing search options available to searchers regarding a document stored in a cloud storage system, depending on the access authorization of the searchers, in accordance with the aspects of the present disclosure.

FIG. 6 is a block diagram showing an example computer system upon which aspects of this disclosure may be implemented.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

This description is directed to allowing an authorized searcher to be able to conduct a search of a of current primary version of a document being developed in an application as well as historical versions of the document which were used in the development of the current primary version of the document.

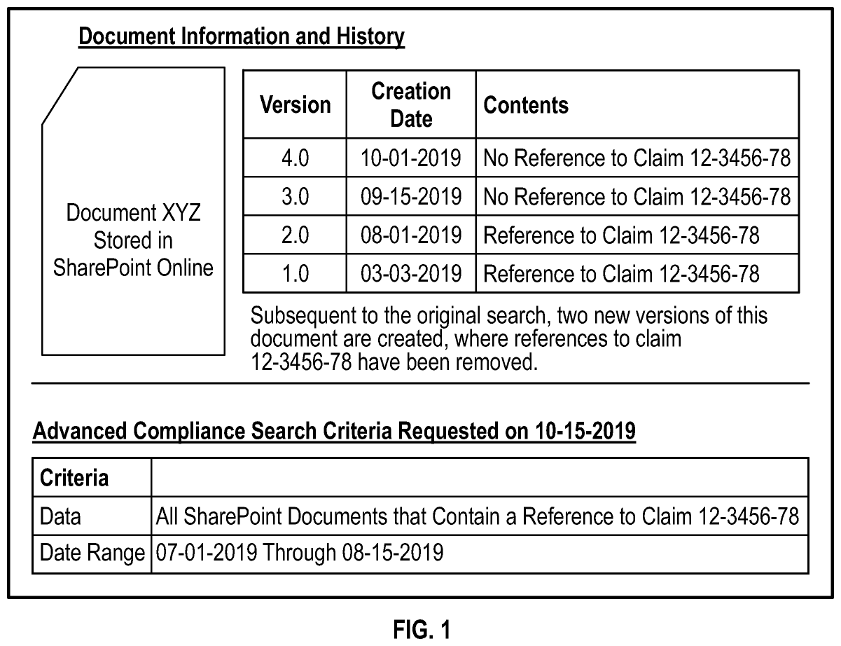

As discussed above with regard to FIG. 1, in previous systems a searcher was not able to access all of the necessary information required, for example, for a search used for legal discovery, or during an audit, with regard to the document for a project under study or investigation. Using aspects of the present disclosure discussed below, it is possible to uncover material, such as the Document XYZ shown in FIG. 1, from an earlier version of a document under development in a document and data management program than was previously possible using a search index of a cloud storage tool.

It is noted that the document storage application SharePoint Online™ supports the concept of so-called “minor versions,” which are, in effect, versions of a document under development. These minor versions are used to control who has access to “in progress” work. For example, the members of a group involved in developing a document in the application program might be able to see a minor version (e.g., Version (2.3)). But when a visiting searcher, who is not a member of the development group, and who has only read permission, attempts to perform a search, they will only see the last “major version” (e.g., Version 2.0, which is a primary version which one or more of the group members, or an Administrator, determined to be available for read-only viewing by searchers outside of the group). In other words, the push service used to push versions of the document from the application being used to develop the document (e.g., SharePoint Online™) to cloud storage (e.g., a cloud based search index) will submit only the latest major version (e.g., Version 2.0 in this example) to the search index of the cloud storage. As such, although the application developing the document supports the concept of “minor” versions, equivalent to versions in the present disclosure, the search index the cloud storage used for such applications in previous systems does not allow access to such minor versions. In conjunction with this, the Access Control Lists (ACLs) and security trimming for the push service assume all pushed documents are major versions.

It is noted that the present disclosure has particular usefulness with regard to conducting legal discovery for legal proceedings, or similar searches, such as audits. In conjunction with such legal discovery, it is noted that the term “discovery compliance” means that each party (in this case prosecution and defense) must comply with court orders regarding sharing any information relevant to the case in their possession. Electronic discovery, as used herein, refers to any process in which electronic data is sought, located, secured, and searched for using it as evidence in a case. In the process of electronic discovery, data of all types can serve as evidence.

It is also noted that, in the following description, the terminology “legal or litigation hold” is the process an organization employs when litigation is plausibly anticipated. The legal hold mandates preservation of documentation, pertaining to a grievance or an audit. All processes leading to disposal of data are suspended to ensure data availability for the discovery process prior to actual litigation.

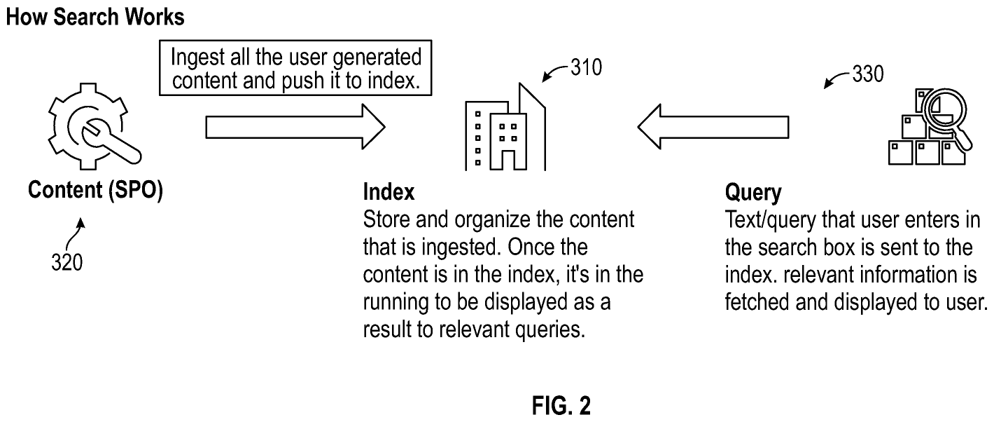

FIG. 2 illustrates an overview of how a search for information in stored documents works using an index of the storage system (e.g., cloud storage), in accordance with aspects of the present disclosure. The storage system includes an index 310 (in effect, an indexing unit) which is part of a cloud storage system. Specifically, the index 310 is designed to store and organize the content that is ingested into the cloud storage from the application content 320 of an application in which a document is being developed. As will be discussed in further detail below, the index 310 can be made up of two separate index portions 310a and 310b. As discussed, the index portion 310b stores and/or allows access to only a current primary version of the document under development, whereas index portion 310a stores and/or allows access not only to the current primary version, but also to stored historical versions and previous primary versions. In implementations of the present disclosure, the index portion 310a can actually store the historical versions 425 and the primary versions 420 in storage devices that are part of the index portion 310a. In alternative implementations of the present disclosure, rather than actually storing the historical versions 425 and primary versions 420, the index portion 310a can store links, effectively serving as pointers, to the stored versions, which are stored in a separate storage device.

Once the content 320 is in the index 310, this content is eligible to be displayed as a result of relevant queries 330 from eligible searchers (who may or may not also be users from the group involved in developing the document in the document storage application). A query 330 can be a text/query that a user or other searcher enters in a search box to send to the index 310. In response to the query 330, the index 310 can fetch the requested information from the cloud storage and provide it to the requestor for display.

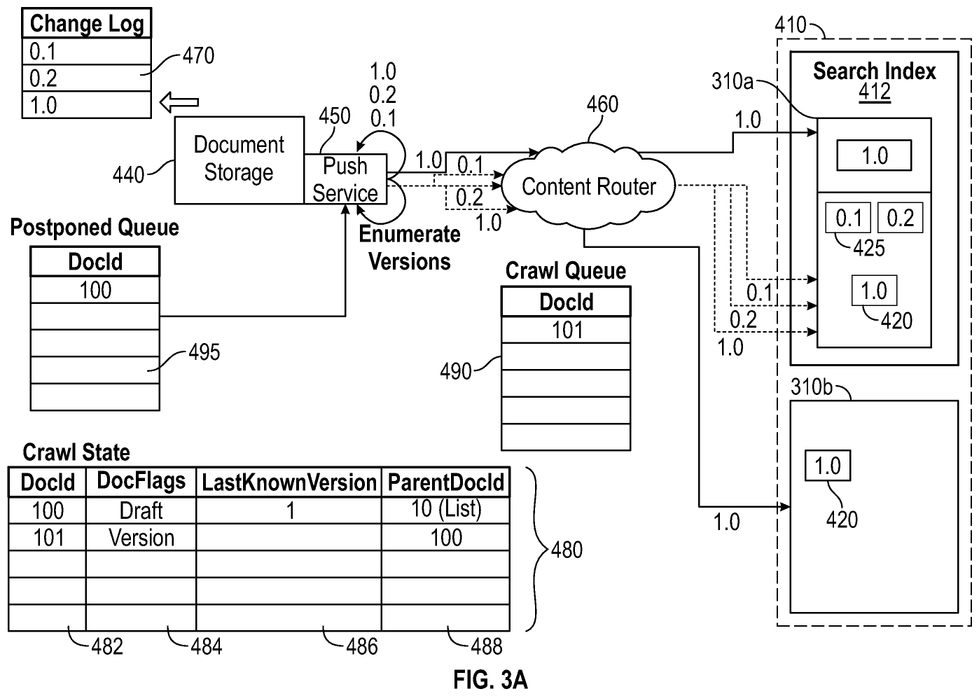

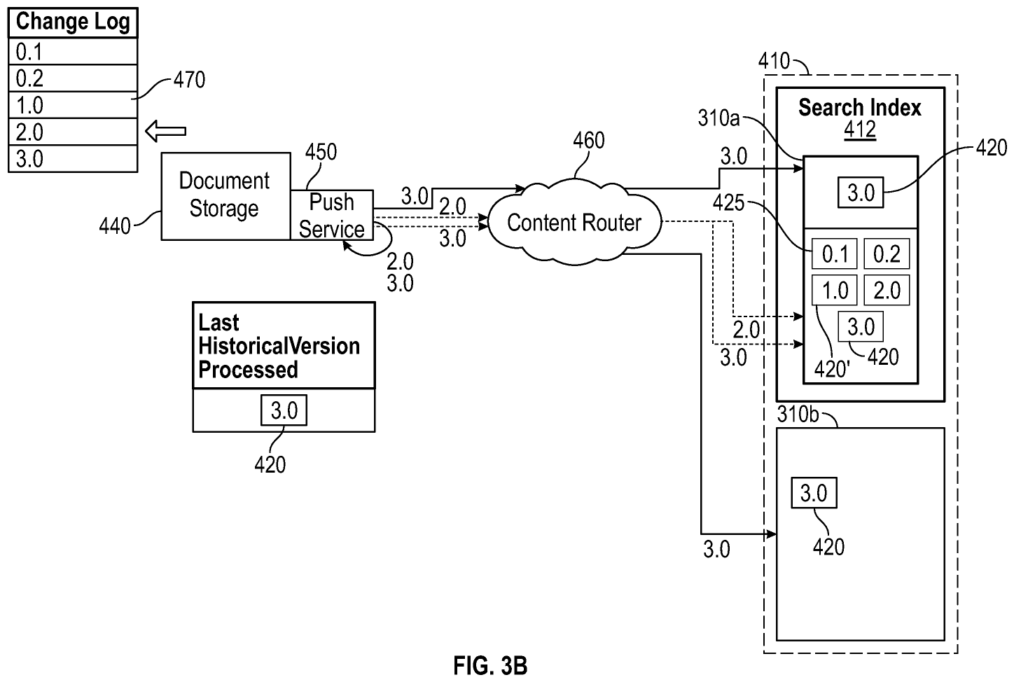

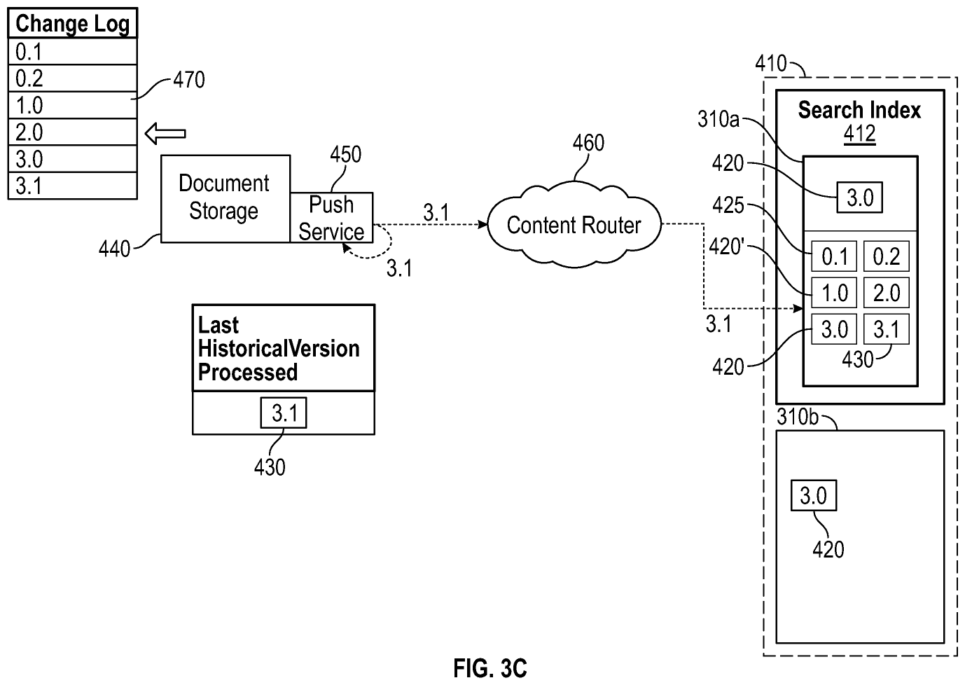

FIGS. 3A-3C show a system for allowing authorized searchers to search the index 310 (specifically, a search index 412 made up of the index portions 310a and 310b in FIGS. 3A-3C) to be able to search not only current primary versions 420 (e.g., Versions 1.0, 2.0 and 3.0 in FIGS. 3A-3C) of a document stored in cloud storage 410 (which includes the search index 412 to provide cloud services), but also draft versions 425 (e.g., Versions 0.1, 0.2), and previous primary versions 420′ of the document. Versions 425 which have been pushed to the index portion 310a before the current primary version 420, and previous primary versions 420′ are historical versions of the document relative to the current primary version 420.

As shown in FIG. 3C, authorized searchers can also be allowed to search stored new head versions 430 (e.g., Version 3.1) which have been stored after a current primary version (e.g., Version 3.0) has been selected. FIGS. 3A-3C also show the current primary version 420 being provided in index portion 310b for access to the current primary version 420 by searchers having only a limited access authorization, such as read-only authorized searchers who are not part of the group authorized to make changes to the document. In other words, once a historical version 425 has been selected to be the current primary version 420, it will be accessible in both the index portion 310a, along with the historical versions 425 and previous primary versions 420′, and in the index portion 310b, which is the only index portion accessible to limited access authorization searchers, such as read-only searchers who are not authorized users regarding the document being developed in a document storage application 440.

FIGS. 3A-3C also show the push arrangement between a document storage application 440, in which the document is being developed by a group of users, and the cloud storage 410. Solely for purposes of non-limiting example, the application 440 shown in the drawing can be an application such as SharePoint Online™. However, it is to be understood that the application 440 could be any document storage application, which is configured to allow document development by a plurality of users working together to contribute to the development of the document.

More specifically, a content push service 450 pushes selected ones of versions 425 of the documents being developed by the group of users in the application 440 to the indexes 310a and 310b through a content router 460. The content push service 450 and the content router 460 are standard elements used with data management applications for pushing versions that have been developed in the application 440 to a search index in cloud storage. In accordance with aspects of the present disclosure, the decision as to which ones of versions 425 of the document being developed in the application 440 to push to the cloud storage 410 (and, in particular, to the portion 310a of the search index) to be stored as historical versions 425 is made based on a variety of possible criteria.

For example, in accordance with aspects of the present disclosure, the determination as to when to push the selected one or more of the versions from the application 440 to the index portion 310a of cloud storage 410, using the push service 450, is based on at least one of the following determining factors: (1) a ranking of the users making changes to the selected one or more of the versions in the application 440 regarding a level of authorization for making changes to the document; (2) a number of times changes have been made to the selected one or more of the versions in the application 440 by the users since the primary version has been selected; (3) the number of users that are using or modifying the selected one or more of the versions in the application; and (4) how often the selected one or more of the versions is being used in the application 440.

The decision to select a particular version being worked on by one or more users in the application 440, or by an administrator of the application 440, to be a version to be pushed to the index portion 310a, can be made based on just one of the above-noted factors or a combination of two or more of them, including all of them, if desired. Further, weighting could be assigned such as that some of the noted selection factors have more weight than others in terms of the decision to push the version to the index portion 310a as a historical version. For example, factor (1) noted above could have the highest weighting value, factor (2) the second highest weighting value, factor (3) the third highest, and factor (4) the lowest weighting value, assuming that all four factors are given weight in making the decision as to whether a particular version being developed in the application 440 is going to be pushed as a historical version to the index portion 310a. This weighting example is, of course, just one example, and other combinations of the decision factors are envisioned as well.

The decision as to which historical version to select as a primary version to be pushed to the index portions 310a and 310b to be the current primary version 420 can be made by one or more of the users and/or an application administrator. This decision can be made using one or more of the above-noted decision factors that can be used for determining which versions of the document being developed in the application will be pushed as historical versions, or other factors, if desired. Similarly, weighting of decision factors can be used for determining which historical version 425 will be selected to be the current primary version 420, if desired, similar to the weighting described above for deciding which versions to push.

Still referring to FIGS. 3A-3C, each figure includes a change log 470 which stores and indicates the events, i.e., the historical versions and primary versions of the document that have been previously selected by the criteria noted above to push from the application 440 to the index portions 310a and 320b of the cloud storage 410 via the document storage 450 and the content router 460. For example, the change log 470 in FIG. 3A indicates that only two historical versions 0.1 and 0.2 have been pushed to the index portion 310a, and one current primary version 1.0 has been selected and pushed to both the index portion 310a, which is accessible to searchers with higher access authorization, and the index portion 310b, which is the only index portion accessible to searchers with a limited access authorization. The change log 470 in FIG. 3C, on the other hand, shows the document development at a later point in time, at which two new primary versions 2.0 and 3.0 have been developed and pushed to the index portions 310a and 310b, and, in addition, a further new head version 3.1 has been developed and pushed to the index portion 310a. As can be seen in all of FIGS. 3A-3C, a pointer is provided so that a user can quickly determine the state of development of the document from the change log 470.

In addition, as shown in FIG. 3A, as a non-limiting example, the system can also include a crawl state table 480, a crawl queue 490 and a postponed queue 495 which operate together to control crawl search operations of the index portions 310a and 310b in a manner which will be described in further detail below. The crawl state table 480 includes a document ID column 482, a document flags column 484, a last known version column 486 and a parent document ID column 488.

Still referring to FIG. 3A, in this specific example, the crawl state table 480 has two document IDs listed in the document ID column 482. The first listed document is a document 100, shown as being a version in the document flags column 484, with the last known version that the document 100 pertaining to primary Version 1.0. The parent document for the document 100 is shown in the parent document ID column 488 as a document 10 (List). A second document 101 is also listed in the document ID column 482, and is shown as a “version” in the document flag column 484 with a parent document being the document 100.

Still referring to FIG. 3A, the document 101 from the document ID column 482 is also shown as being in the crawl queue 490, awaiting a crawl operation. The document 100, meanwhile, is in the postponed queue 495. As shown by the arrow between the postponed queue 495 and the push service 450, the document 100, related to the last known Version 1.0 is provided to the push service 450 for processing and to be pushed to the index portions 310a and 310b of the cloud 410.

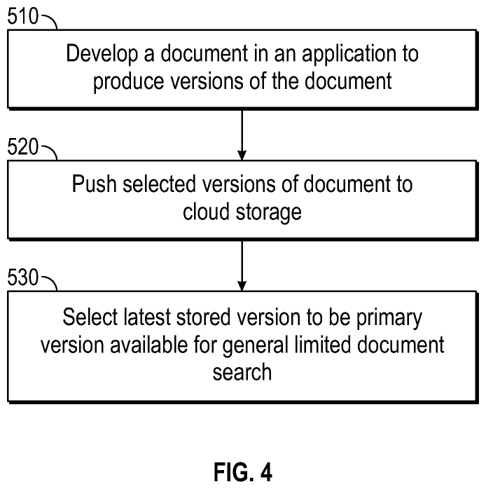

FIG. 4 is a flow diagram showing operations for pushing selected historical versions 425 of a document under development to the index portion 310a of FIGS. 3A-3C, and selection of one of the selected historical versions 425 to become a current primary version 420 of the document for general searching in a search index, for example in the search index 310b of FIGS. 3A-3C, in accordance with the aspects of the present disclosure. As shown in FIG. 4, at step 510, a document is developed in an application 440 based on contributions of a plurality of users to produce versions of the document in the application 440. In step 520 one or more selected ones of the historical versions 425 are pushed via the push service 450 from the application 440 to the index portion 310a of the cloud storage as stored historical versions in the cloud storage 410. This is performed using the determination factors discussed above as to which one of the document versions under development in the application 440 will be pushed to the cloud storage 410. At step 530, one of the stored historical versions 425 of the document is selected to be a primary version 420 of the document which is accessible to searchers with a limited access authorization via the search index portion 310b, as well as being accessible to higher access authorization searchers in the index portion 310a.

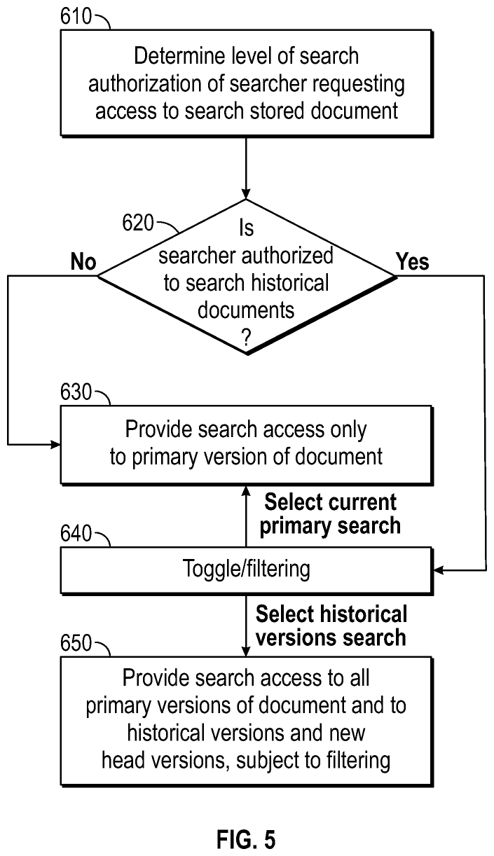

FIG. 5 is a flow diagram of search options available to searchers with respect to a document stored in a cloud storage system 410, depending on the access authorization of the searchers, in accordance with the aspects of the present disclosure. In step 610, the level of access authorization of a searcher requesting access to the search index 310 is determined with regard to versions of the document that have been pushed to the search index 310 (including the index portions 310a and 310b). At step 620, it is determined, based on the information determined in step 610, whether the searcher is authorized to search the historical versions 425 found in the search index 310a or is authorized to search only the current primary version 420 of the document, available in index portion 310b. If the determination in step 620 is that the searcher is allowed access only to the current primary version 420, then the operation proceeds to step 630. If, however, the determination in step 620 is that the searcher has access to both the current primary version 420 and the stored historical versions 425, then the operation proceeds to step 640, for filtering. This filtering for searchers having the higher access authorization can allow the searchers to limit dates of searching of the stored minor versions of the document. Alternatively, this filtering can allow the searchers to limit searching of the stored historical versions of the document to see only revisions which the searchers themselves have made. It is also noted that, for searchers with the higher access authorization, a toggle arrangement can be provided, for example, as part of the filtering step 640, allowing the searcher to limit the search to the current primary version 420 to perform only a limited search, if desired. On the other hand, if the searcher with the higher level of authorization selects conducting a more detailed search that includes the historical versions and/or previous primary versions of the document, the operation will proceed to step 650 to provide search access to all primary versions of the document, all historical versions and all new versions that are stored or accessible through the search index portion 310b.

In accordance with aspects of the present disclosure, versions 425 that are pushed by the push service 450 to the cloud storage 410 can be made immutable, i.e., supporting only add and delete options in the push service 450 and the index 310. In conjunction with this, the push service 450 will treat the versions 425, which will become historical versions in the index portion 310a, will be treated as a child link of a corresponding primary version (e.g., the historical version 0.1 will be a child link of the primary version 1.0 for which it will become a historical version. To this end, each historical version will be a separate item in the search index 412 with a unique identifier that includes a version ID so that each historical version is distinct and separate from the current primary version. Also, to achieve this immutability of the historical versions 425 that are stored in the index portion 310a, an access control list (ACL) that provides rules for granting or denying access to the stored versions of the document, must be set to null. This is necessary in data management applications because ACLs are generally not versioned in such applications and because such ACLs do not support historical versions that are not immutable.

Since historical versions 425 will be treated as child links of the current primary version in this implementation where the versions 425 are immutable, any deep update in the site (rename, move, recrawl) would cause all historical versions to be updated. This is potentially a large amount of extra load for very little value. To mitigate such an excess load, the push service 450 will treat the historical versions 425 as immutable. This means that 450 will support only add and delete operations for the historical versions 425. Push service 450 will not update the historical versions 425 when the current primary version 420 is updated. This means that all crawl properties on the historical versions 425 must be immutable in the cloud storage 410 to be included in the historical versions.

The path on the historical versions 425 in the application 440 is not immutable, and it is always the same as the current primary version. Since the path is not immutable in the application 440, the push service 450 will not include the path as a crawl property in the historical versions 425. This means that path-based electronic discovery queries for historical versions 425 will not be supported.

In the implementation using immutable historical versions 425, in the application 440 the version URLs for historical versions are based on the path of the current primary version 420. Since the version URL is not immutable, the push service 450 will not include the version URLs as a crawl property. This means that a search client will need to query for the current primary version 420 in order to get the version URL. The proposed solution is to expose a new document storage API and take new IDs to return the correct version URL. This also abstracts to complexity of building the version URL as different file types have different version URL formats (files, items, pages).

As part of the immutable historical version design, push service 450 will not propagate list moves to historical versions. This means that historical versions will not have certain crawl properties because these crawl properties are not immutable within a site. These crawl properties can be retrieved from the current primary version by looking up a date of the current primary version in search index 412.

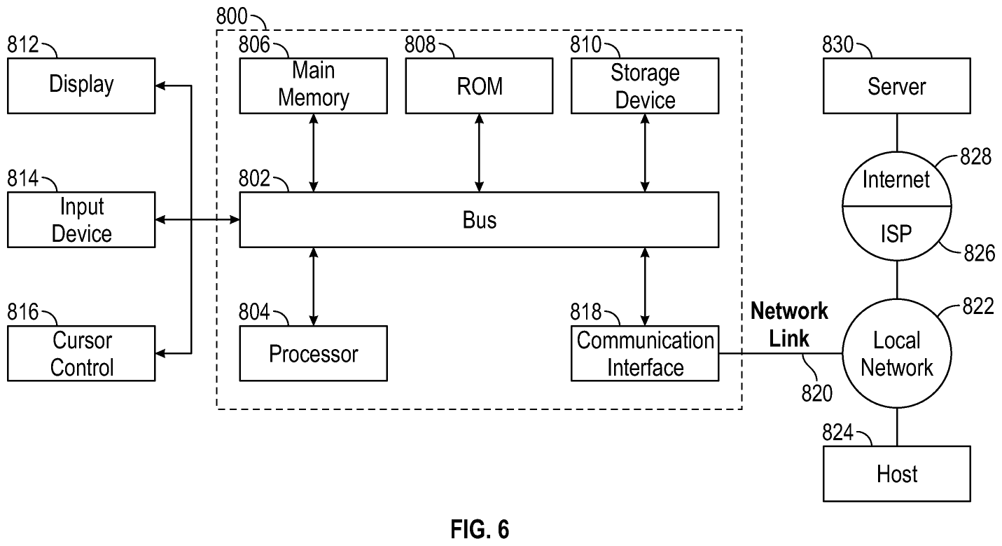

FIG. 6 is a block diagram showing an example a computer system 800 upon which aspects of this disclosure may be implemented. The computer system 800 may include a bus 802 or other communication mechanism for communicating information, and a processor 804 coupled with the bus 802 for processing information. The computer system 800 may also include a main memory 806, such as a random-access memory (RAM) or other dynamic storage device, coupled to the bus 802 for storing information and instructions to be executed by the processor 804. The main memory 806 may also be used for storing temporary variables or other intermediate information during execution of instructions to be executed by the processor 804. The computer system 800 may implement, for example, a computer for running the application 440, and servers for the cloud system 410.

The computer system 800 may further include a read only memory (ROM) 808 or other static storage device coupled to the bus 802 for storing static information and instructions for the processor 804. A storage device 810, such as a flash or other non-volatile memory may be coupled to the bus 802 for storing information and instructions.

The computer system 800 may be coupled via the bus 802 to a display 812, such as a liquid crystal display (LCD), for displaying information. One or more user input devices, such as the example user input device 814 may be coupled to the bus 802, and may be configured for receiving various user inputs, such as user command selections and communicating these to the processor 804, or to the main memory 806. The user input device 814 may include physical structure, or virtual implementation, or both, providing user input modes or options, for controlling, for example, a cursor, visible to a user through display 812 or through other techniques, and such modes or operations may include, for example virtual mouse, trackball, or cursor direction keys.

The computer system 800 may include respective resources of the processor 804 executing, in an overlapping or interleaved manner, respective program instructions. Instructions may be read into the main memory 806 from another machine-readable medium, such as the storage device 810. In some examples, hard-wired circuitry may be used in place of or in combination with software instructions. The term “machine-readable medium” as used herein refers to any medium that participates in providing data that causes a machine to operate in a specific fashion. Such a medium may take forms, including but not limited to, non-volatile media, volatile media, and transmission media. Non-volatile media may include, for example, optical or magnetic disks, such as storage device 810. Transmission media may include optical paths, or electrical or acoustic signal propagation paths, and may include acoustic or light waves, such as those generated during radio-wave and infra-red data communications, that are capable of carrying instructions detectable by a physical mechanism for input to a machine.

The computer system 800 may also include a communication interface 818 coupled to the bus 802, for two-way data communication coupling to a network link 820 connected to a local network 822. The network link 820 may provide data communication through one or more networks to other data devices. For example, the network link 820 may provide a connection through the local network 822 to a host computer 824 or to data equipment operated by an Internet Service Provider (ISP) 826 to access through the Internet 828 a server 830, for example, to obtain code for an application program.

In the following, further features, characteristics and advantages of the invention will be described by means of items:
Item 1. A system which includes one or more processors, and one or more machine-readable media storing instructions which, when executed by the one or more processors, cause the one or more processors to grant a first search request from a first searcher having a predetermined access authorization, to search, via a search index in a cloud storage, stored selected versions of a document, in which stored selected versions have been developed in an application based on contributions of a plurality of users to produce versions of the document in the application, wherein the stored selected versions of the document are historical versions of a current primary version of the document which has been selected from among the stored selected versions to be accessible, via the search index, to other searchers having a lower access authorization than the predetermined access authorization, other searchers do not have access to the stored selected versions, and the first searcher is provided with a capability to toggle between searching only the primary version of the document and searching the stored selected versions of the document.
Item 2. The system of item 1, wherein a determination as to when to push the selected one or more of the versions from the application to the cloud storage is based on at least one of: a ranking of the users making changes to the selected one or more of the versions in the application in relation to a level of authorization for making changes to the document; a number of times changes have been made to the selected one or more of the versions in the application by the users since the primary version has been selected; the number of users that are using or modifying the selected one or more of the versions in the application; and how often the selected one or more of the versions is being used in the application.
Item 3. The system of items 1 or 2 wherein the instructions, when executed by the one or more processors, cause the one or more processors to provide access, via the search index, to the first searcher with the higher access authorization to new versions of the document stored in the cloud storage, which new versions of the document have been developed by the users in the application after selection of the primary version.
Item 4. The system of any of items 1-3, wherein the instructions, when executed by the one or more processors, cause the one or more processors to provide filtering for the first searcher having the higher access authorization to allow the first searcher to limit dates of searching of the stored selected versions of the document.
Item 5. The system of any of items 1-4, wherein the instructions, when executed by the one or more processors, cause the one or more processors to provide filtering for the first searcher having the higher access authorization to allow the first searcher to limit dates of searching of the stored selected versions of the document.
Item 6. The system of any of items 1-5, wherein the stored selected versions are stored as immutable versions in the cloud storage.
Item 7. A method including developing a document in an application based on contributions of a plurality of users to produce versions of the document in the application, pushing one or more selected ones of the versions from the application to cloud storage as stored versions in the cloud storage, and selecting a latest one of the stored versions of the document to be a primary version of the document which is accessible to searchers with a limited access authorization via a search index, wherein a determination as to when to push the selected one or more of the versions from the application to the cloud storage is based on at least one of: a ranking of the users making changes to the selected one or more of the stored versions in the application in relation to a level of authorization for making changes to the document; a number of times changes have been made to the selected one or more of the versions in the application by the users since the primary version has been selected; the number of users that are using or modifying the selected one or more of the versions in the application; and how often the selected one or more of the versions is being used in the application.
Item 8. The method of item 7, further comprising providing access, via the search index, to searchers having a higher access authorization than the limited access authorization to the stored versions as historical versions used to develop the primary version of the document.
Item 9. The method of item 7 or 8, further comprising pushing one or more new versions of the document, developed by the users in the application after selection of the primary version, to the cloud storage.
Item 10. The method of any one of items 7-9, further comprising providing access, via the search index, to the searchers with the higher access authorization to the new versions of the document stored in the cloud storage.
Item 11. The method of any one of items 7-10, further comprising replacing the previously stored primary version with a new primary version, selected from one of the stored new versions, to store in the cloud storage.
Item 12. The method of any one of items 7-11, wherein the searchers with the limited access authorization have access, via the search index, to only the new primary version of the document through the search index and not to the previously stored primary version, and wherein the searchers with the higher access authorization have access, via the search index, to the primary version of the document as a historical version of the document in the cloud storage.
Item 13. The method of any one of items 7-12, wherein the users have different levels of authorization to perform at least one of: changes to the document; decisions about timing of storage of the versions of the document as the stored versions; and decisions about selecting one of the stored versions of the document to be the new primary version of the document to replace to the previous primary version of the document.
Item 14. The method of any one of items 7-13, wherein the selecting of one of the stored versions to being the new primary version of the document is based on a determination by one or more of the users having authorization to designate one of the stored versions as the new primary version.
Item 15. The method of any one of items 7-14, further comprising allowing only searchers with the higher access authorization to toggle between conducting a first search of the primary version of the document via the search index and conducting a second search of the primary version and the historical versions of the versions and the previous primary versions via the search index.
Item 16. The method of any one of items 7-15, further comprising providing filtering for searchers having the higher access authorization to allow the searchers to limit dates of searching of the stored minor versions of the document.
Item 17. The method of any one of items 7-16, further comprising providing filtering for searchers having the higher access authorization to allow only the searchers to limit searching of the stored versions of the document to see only revisions which the searchers themselves have made.
Item 18. The method of any one of items 7-17, wherein the stored versions are stored as immutable versions in the cloud storage.
Item 19. The method of any one of items 7-18, wherein the determination as to when to store the selected one of the versions of the document as the primary version of the document is based on the ranking of the users making changes to the versions regarding a level of authorization for making changes to the document.
Item 20. The method of any one of items 7-19, wherein the determination as to when to store the selected one of the versions of the document as the primary version of the document is based on the number of times changes have been made to the one of the version of the project by the users since the primary version has been stored.
Item 21. The method of any one of items 7-20, wherein the determination as to when to store one of the versions of the document as the primary version of the document is based on the number of users that are using or modifying the selected one of the versions.
Item 22. The method of any one of items 7-21, wherein the determination as to when to store the selected one of the versions of the document as the primary version of the document is based on how often the selected one of the versions is being used.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system comprising:
one or more processors; and
one or more machine-readable media storing instructions which, when executed by the one or more processors, cause the one or more processors to grant a first search request from a first searcher having a predetermined access authorization, to search, via a search index in a cloud storage, stored selected versions of a document, in which stored selected versions have been developed in an application based on contributions of a plurality of users to produce versions of the document in the application, wherein:
the stored selected versions of the document are historical versions of a current primary version of the document which has been selected from among the stored selected versions to be accessible, via the search index, to other searchers having a lower access authorization than the predetermined access authorization,
other searchers do not have access to the stored selected versions, and
the first searcher is provided with a capability to toggle between searching only the primary version of the document and searching the stored selected versions of the document.

2. The system of claim 1, wherein a determination as to when to push the selected one or more of the versions from the application to the cloud storage is based on at least one of: a ranking of the users making changes to the selected one or more of the versions in the application in relation to a level of authorization for making changes to the document; a number of times changes have been made to the selected one or more of the versions in the application by the users since the primary version has been selected; the number of users that are using or modifying the selected one or more of the versions in the application; and how often the selected one or more of the versions is being used in the application.

3. The system of claim 2, wherein the instructions, when executed by the one or more processors, cause the one or more processors to provide access, via the search index, to the first searcher with the higher access authorization to new versions of the document stored in the cloud storage, which new versions of the document have been developed by the users in the application after selection of the primary version.

4. The system of claim 3, wherein the instructions, when executed by the one or more processors, cause the one or more processors to provide filtering for the first searcher having the higher access authorization to allow the first searcher to limit dates of searching of the stored selected versions of the document.

5. The system of claim 3, wherein the instructions, when executed by the one or more processors, cause the one or more processors to provide filtering for the first searcher having the higher access authorization to allow the first searcher to limit searching of the stored selected versions of the document to see only revisions which the first searcher has made in the stored selected versions.

6. The system of claim 3, wherein the stored selected versions are stored as immutable versions in the cloud storage.

7. A method comprising:
developing a document in an application based on contributions of a plurality of users to produce versions of the document in the application;
pushing one or more selected ones of the versions from the application to cloud storage as stored versions in the cloud storage; and
selecting a latest one of the stored versions of the document to be a primary version of the document which is accessible to searchers with a limited access authorization via a search index,
wherein a determination as to when to push the selected one or more of the versions from the application to the cloud storage is based on at least one of: a ranking of the users making changes to the selected one or more of the stored versions in the application in relation to a level of authorization for making changes to the document; a number of times changes have been made to the selected one or more of the versions in the application by the users since the primary version has been selected; the number of users that are using or modifying the selected one or more of the versions in the application; and how often the selected one or more of the versions is being used in the application.

8. The method of claim 7, further comprising providing access, via the search index, to searchers having a higher access authorization than the limited access authorization to the stored versions as historical versions used to develop the primary version of the document.

9. The method of claim 8, further comprising pushing one or more new versions of the document, developed by the users in the application after selection of the primary version, to the cloud storage.

10. The method of claim 9, further comprising providing access, via the search index, to the searchers with the higher access authorization to the new versions of the document stored in the cloud storage.

11. The method of claim 10, further comprising replacing the previously stored primary version with a new primary version, selected from one of the stored new versions, to store in the cloud storage.

12. The method of claim 11, wherein the searchers with the limited access authorization have access, via the search index, to only the new primary version of the document through the search index and not to the previously stored primary version, and wherein the searchers with the higher access authorization have access, via the search index, to the primary version of the document as a historical version of the document in the cloud storage.

13. The method of claim 12, wherein the users have different levels of authorization to perform at least one of: changes to the document; decisions about timing of storage of the versions of the document as the stored versions; and decisions about selecting one of the stored versions of the document to be the new primary version of the document to replace to the previous primary version of the document.

14. The method of claim 13, wherein the selecting of one of the stored versions to being the new primary version of the document is based on a determination by one or more of the users having authorization to designate one of the stored versions as the new primary version.

15. The method of claim 14, further comprising allowing only searchers with the higher access authorization to toggle between conducting a first search of the primary version of the document via the search index and conducting a second search of the primary version and the historical versions of the versions and the previous primary versions via the search index.

16. The method of claim 15, further comprising providing filtering for searchers having the higher access authorization to allow the searchers to limit dates of searching of the stored minor versions of the document.

17. The method of claim 15, further comprising providing filtering for searchers having the higher access authorization to allow only the searchers to limit searching of the stored versions of the document to see only revisions which the searchers themselves have made.

18. The method of claim 7, wherein the stored versions are stored as immutable versions in the cloud storage.

19. The method of claim 7, wherein the determination as to when to store the selected one of the versions of the document as the primary version of the document is based on the ranking of the users making changes to the versions regarding a level of authorization for making changes to the document.

20. The method of claim 7, wherein the determination as to when to store the selected one of the versions of the document as the primary version of the document is based on the number of times changes have been made to the one of the version of the project by the users since the primary version has been stored.

21. The method of claim 7, wherein the determination as to when to store one of the versions of the document as the primary version of the document is based on the number of users that are using or modifying the selected one of the versions.

22. The method of claim 7, wherein the determination as to when to store the selected one of the versions of the document as the primary version of the document is based on how often the selected one of the versions is being used.
